(19) United States
(12) Patent Application Publication
(10) Pub. No.: US 2006/0200452 A1
(43) Pub. Date: Sep. 7, 2006

(54) METHOD FOR TRANSLATING SYNTAX OF PATENT INFORMATION SEARCH

(75) Inventors: CHUNG-I LEE, Tu-Cheng (TW); CHIEN-FA YEH, Tu-Cheng (TW); XIAO-DI FAN, SHENZHEN (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,921

(22) Filed: Jan. 17, 2006

(30) Foreign Application Priority Data
Jan. 21, 2005 (TW) 94101774

(51) Int. Cl. G06F 17/30

(52) U.S. Cl. 707/3; 707/104.1

(57) ABSTRACT

A method for translating syntax of patent information search includes the steps of: receiving a search string; parsing the syntax of the search string and dividing the search string into different parts; generating a syntax tree according to the divided different parts; optimizing the syntax tree; parsing the different parts of the optimized syntax tree and determining a type for each part; and translating the search string to one or more search sentences via loading one or more corresponding Schema Languages.

### FIELD OF THE INVENTION

The present invention relates to a method for translating syntax of patent information search.

### DESCRIPTION OF RELATED ART

Intellectual property (IP) professionals such as patent attorneys, patent agents, law firms, search firms, in-house IP departments of corporations, technology transfer managers, asset-based lenders, and the like perform laborious tasks of searching for, retrieving, analyzing, and organizing various forms of patents.

Patent information is an important portion of information that people in many industries would like to search. Conventional search systems provide IP professionals with basic search and retrieval functions. Database hardware and software have been developed for access by IP professionals and other users through personal computers, mainframes, and other processor-based devices. Users may access and view patent information stored locally on CD-ROMs, stored on network storage devices through a local area network, or stored on remote database systems through one or more disparate network paths (e.g., the Internet).

Electronic searching for patent information has effectively become the preferred searching vehicle, given the vast amount of information available, the complexity of the information, the geographical limitations posed by the various sources of the information, and the technical adeptness of the majority of IP professionals. In general, however, electronic searching methods provide little more than rudimentary searching functions that require the IP professionals to formulate the content and direction of their search strategy through previous experience or simply through trial and error. By and large, the methods are unable to facilitate or automate the creation of search queries and criteria. The methods generally cannot be provided for translating syntax of a search string when the user searches patent information on patent information websites of different countries, which include different search rules. Traditional designing of search programs generally has no unitive syntax description, and the search string needs to match verbatim in a process of syntax parsing. Moreover, it is difficult to maintain the syntax which has complex logic.

What is needed, therefore, is a method which can translate syntax of searching patent information on patent information websites of different countries automatically. Furthermore, other kinds of search sentence can be generated by translating the syntax, such as an SQL (Structured Query Language) search sentence and an XML (Extensible Markup Language) sentence etc. The method provides the syntax parsing according to BNF (Backus Naur Form), which helps the user to search the corresponding patent information easily and quickly. The search program thereof is designed with JavaCC (Java Compiler Compiler), which is easy to maintain the syntax.

### SUMMARY OF INVENTION

A method for translating syntax of patent information search in accordance with another preferred embodiment includes the steps of: receiving a search string; parsing the syntax of the search string and dividing the search string into different parts; generating a syntax tree according to the divided different parts; optimizing the syntax tree; parsing the different parts of the optimized syntax tree and determining a type for each part; and translating the search string to one or more search sentences via loading one or more corresponding Schema Languages.

Other advantages and novel features of the present invention will become more apparent from the following detailed description of preferred embodiments when taken in conjunction with the accompanying drawings, in which:

### BRIEF DESCRIPTION OF DRAWINGS

FIG. 1 is a schematic diagram of hardware configuration of a system for translating syntax of patent information search in accordance with a preferred embodiment;

FIG. 2 is a flowchart of a method for translating syntax of patent information search in accordance with a preferred embodiment by utilizing the system of FIG. 1; and

FIG. 3 is schematic diagram of a syntax tree of a search string illustrated in FIG. 2.

### DETAILED DESCRIPTION

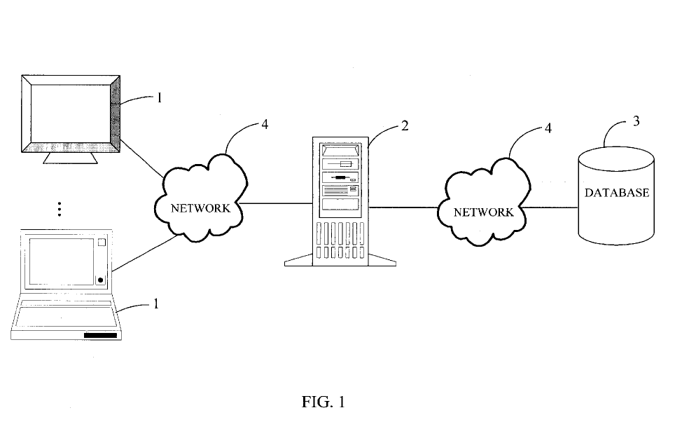

FIG. 1 is a schematic diagram of hardware configuration of a system for translating syntax of patent information search (hereinafter, “the system”) in accordance with a preferred embodiment. The system includes a plurality of client computers 1 (only two shown), an application server 2 and a database 3. The client computers 1 link to the application server 2 via a network 4. The application server 2 connects to the database 3 also through the network 4. The database 3 stores patent information downloaded by the application server 2 from patent information websites of different countries via the network 4. The patent information can be updated by linking the application server 2 to the patent information websites for downloading newly issued patents or published patent applications periodically according to user-defined requirements. The network 4 may be an intranet, the Internet, or any other suitable electronic communications network. The client computers 1 may be common computer devices such as personal computers, laptops and portable handheld devices, or mobile phones and other suitable electronic communication terminals.

Each client computer 1 provides a user interface enabling users to search patent information and review search results. For example, when a user inputs a search string via one of the client computers 1 and sends the search string to the application server 2, the application server 2 parses the syntax of the search string and searches corresponding patent information in the database 3. If the patent information exists in the database 3, the application server 2 sends the search results to the client computer 1. If the patent information does not exist in the database 3, the application server 2 translates the syntax of the search string, searches for the patent information on one or more corresponding patent information websites, and returns the search results to the client computer 1.

The database 3 also stores a syntax reference document. The syntax reference document includes user-defined syntaxes and descriptions corresponding to the syntaxes. For example, in the syntax reference document, ‘title’ of a patent may be described as ‘TTL’; ‘assignee name’ of a patent is described as ‘AN’; ‘abstract’ of a patent is described as ‘ABST’; ‘specification’ of a patent is described as ‘SPEC’; ‘claims’ of a patent is described as ‘ACLM’; ‘patent number’ is described as ‘PN’; ‘application number’ is described as ‘APN’ and ‘issue date’ of a patent is described as ‘ISD,’ etc.

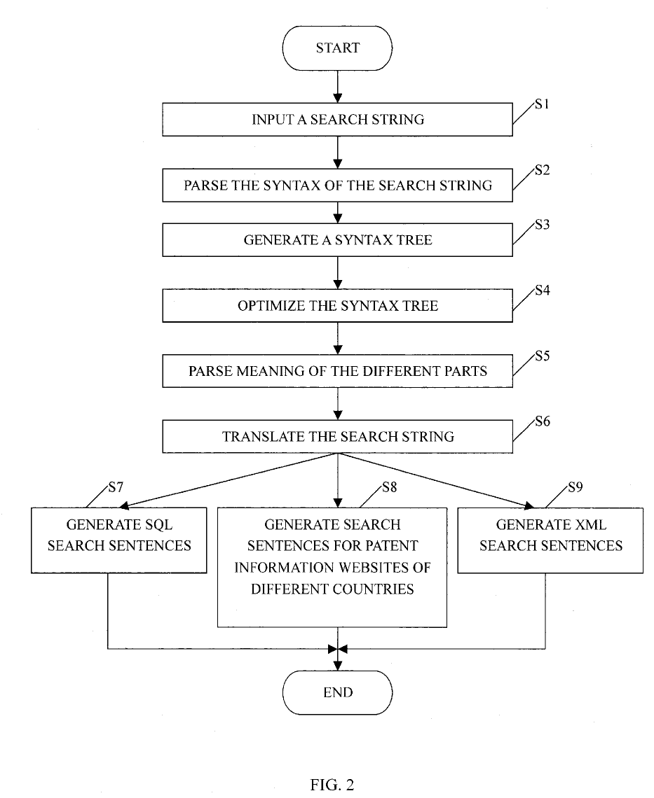

FIG. 2 is a flowchart of a method for translating syntax of patent information search in accordance with a preferred embodiment by utilizing the system of FIG. 1. In step S1, a search string is input by a user through a client computer 1. Definitions of the syntax of the search string are predefined in a syntax reference document stored in the database 3 according to BNF (Backus Naur Form). For example, if the user needs to search for patents issued in 2004, whose assignee names are company A or company B and whose claim language includes the word “connector,” a search string can be input as follows: “AN/(B or C) and ACLM/Connector and ISD/[2004.1.1-2004.12.31],” wherein “AN,” “ACLM” and “ISD” are predefined in the syntax reference document by the user according to BNF.

In step S2, the application server 2 parses the syntax of the search string according to the syntax reference document stored in the database 3. The search string is divided into different parts for distinguishing and analyzing by utilizing JavaCC. For example, the syntax analysis of the search string “AN/(B or C) and ACLM/Connector and ISD/[2004.1.1-2004.12.31]” may include the following JavaCC segments:

<LPAREN: “(”>

<LPAREN: “)”>

<STRING: ([“A”-“Z”, “0”-“9”])+>s

<QUOTED_STRING: “\\″” (˜[“\\″”])+“\\″”>

<AND: (“AND”|“&&”)>

<OR: (“OR”|“||”)>

<TERM: [“AN”,“ACLM”,“ISD”,“ABST”]>

AN/(B or C) and ACLM/Connector AND ISD/[2004.1.1-2004.12.31].

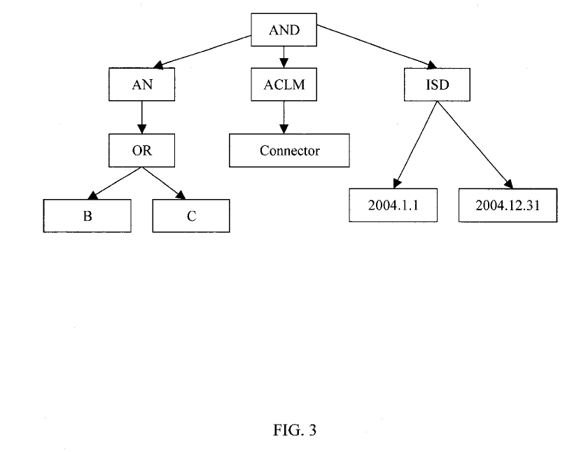

In step S3, the application server 2 generates a syntax tree according to the divided different parts of the search string (shown in detail below in relation to FIG. 3). In step S4, the syntax tree is optimized. Such optimization may include search speed optimization by combining relevant search conditions and key word optimization by deleting unimportant words. For example, if a search string “(AN/B or AN/C)” is input when the user needs to search for patents that belong to company A or company B, in this step, the search string can be optimized to “AN/(B or C).” For another example, if a search string “ACLM/a Connector” is input when the user needs to search for patents whose claim language includes “a connector,” in this step, the search string can be optimized to “ACLM/Connector.” In step S5, the application server 2 parses the meaning of the different parts of the optimized syntax tree, and determines a type for each part. For example, the application server 2 parses the meaning of “AN” as an assignee name of a patent, and determines that the type of “AN” is a character. For another example, the application server 2 parses the meaning of “ISD” as an issue date of a patent, and determines that the type of “ISD” is a date.

In step S6, the application server 2 translates the search string to one or more search sentences via loading one or more corresponding Schema Languages according to different situations. Specifically, in step S7, SQL (Structured Query Language) search sentences are generated by translating the search string when the user searches for patent information in the database 3. For example, the above search string “AN/(B or C) and ACLM/Connector and ISD/[2004.1.1-2004.12.31]” is translated to the following SQL search sentences:

(CONTAINS(PATENT_INFO. TX$ASN_NAME,

‘B or C’)>0 and CONTAINS (PATENT_INFO. TX$PNT_CLAM, ‘Connector’)>0) and DECISION_DATE TO_DATE(‘2004.1.1’,‘yyyy.mm.dd’) and TO_DATE(‘2004.12.31’,‘yyyy.mm.dd’).

In step S8, if no patent information corresponding to the search string is searched in the database 3, different search sentences are generated in order to search on corresponding patent information websites of different countries. In step S9, XML (Extensible Markup Language) search sentences are generated by translating the search string, wherein the XML search sentences are easy to be translated to other search sentences having different formats, such as document search, ‘google’ search, etc.

In the process of translation, codes with different formats are generated by translating the search string. The translation of the search string may be done by one of the two manners: inserting Java codes into JavaCC script and generating a dynamic tree structure by utilizing JJTree, wherein the JJTree is a plug-in of JavaCC.

FIG. 3 is schematic diagram of a syntax tree of a search string illustrated in FIG. 2. As described in FIG. 2, the syntax tree as shown in FIG. 3 is generated after parsing the syntax of the search string of “AN/(B or C) and ACLM/Connector and ISD/[2004.1.1-2004.12.31].”

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A computer-based method for translating syntax of patent information search, comprising the steps of:
receiving a search string;
parsing the syntax of the search string and dividing the search string into different parts;
generating a syntax tree according to the divided different parts;
optimizing the syntax tree;
parsing the different parts of the optimized syntax tree and determining a type for each part; and
translating the search string to one or more search sentences via loading one or more corresponding Schema Languages.

2. The method according to claim 1, wherein the translating step comprises:
generating one or more search sentences in order to search on corresponding patent information websites of different countries.

3. The method according to claim 1, wherein the translating step comprises:
generating SQL (Structured Query Language) search sentences.

4. The method according to claim 3, wherein the SQL search sentences are for searching patent information in a database.

5. The method according to claim 1, wherein the translating step comprises: generating XML (Extensible Markup Language) search sentences.

6. The method according to claim 1, wherein the syntax of the search string is parsed by utilizing JavaCC (Java Compiler Compiler).
